(19) United States
(12) Patent Application Publication
(10) Pub. No.: US 2010/0095281 A1
(43) Pub. Date: Apr. 15, 2010

(54) Internal Function Debugger

(75) Inventor: Jason Neal Raber, Bellbrook, OH (US)

Correspondence Address: KEITH D. NOWAK, CARTER LEDYARD & MILBURN LLP, 2 WALL STREET, NEW YORK, NY, 10005, US

(73) Assignee: Riverside Research INstitute

(21) Appl. No.: 12/250,538

(22) Filed: Oct. 14, 2008

(51) Int. Cl. G06F 9/44

(52) U.S. Cl. 717/129

(57) ABSTRACT

A stealthy internal function (IF) debugger that leverages control flow detours can escape detection by traditional anti-debugging methods. Software that attempts to impede reverse engineering via dynamic analysis, by using anti-debugging or packing measures can be thwarted by using a stealthy IF debugger. Data mining through an IF utility can aid reverse engineering by constructing a data and code flow analysis after an execution of a program.

### TECHNICAL FIELD

The invention relates generally to software security and more particularly, to debugging and reverse engineering of malicious or viral-type software

### BACKGROUND

Dynamic analysis is a powerful tool for reverse engineering. However, malicious software, such as viruses, worms, Trojan horse programs, spyware, and other malware, may use anti-debugging or packing measures in order to make dynamic analysis more difficult. Anti-debugging increases the amount of time it takes for identifying, understanding malware algorithms, which may delay the time before a fix becomes available. Typical anti-debugging techniques attempt to detect debugging breakpoints, for example by searching for INT 3, or CC values, or the use of DR0-DR7 hardware registers. Some anti-debugging techniques attempt to determine whether a debugger has registered with the operating system (OS). Unfortunately, many debuggers are detectable using these techniques.

### SUMMARY

A stealthy internal function (IF) debugger that leverages control flow detours to emulate breakpoints can escape detection by traditional anti-debugging methods. Attempts to impede reverse engineering via dynamic analysis, by using anti-debugging or packing measures, can be thwarted by using a stealthy IF debugger. Data mining through an IF utility can aid reverse engineering by constructing a data and code flow analysis after a single run of an executable program.

The foregoing has outlined the features and technical advantages of the invention in order that the description that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a software program capable of detecting standard debuggers;

FIG. 2 illustrates another software program capable of detecting standard debuggers;

FIG. 3 illustrates another software program capable of detecting standard debuggers;

FIG. 4 illustrates the output of a software program capable of detecting standard debuggers;

FIG. 5 illustrates a computing system having a user application embodied on a computer readable medium, the program comprising instructions configured to be executed by a processor;

FIG. 6 illustrates a software control flow detour process graph, adaptable for use as a stealthy internal function (IF) debugger and data miner;

FIG. 7 illustrates a comparison between user memory spaces with and without MS Detours;

FIG. 8 illustrates a comparison between software control flow detour process graphs with and without MS Detours;

FIG. 9 illustrates a method 900 of stealthy debugging;

FIG. 10 illustrates a program to be debugged;

FIG. 11 illustrates a screenshot taken while running software with an embodiment of a stealthy debugger;

FIG. 12 illustrates a screenshot of the help screen of an IF debugger;

FIG. 13 illustrates a screenshot of a debugging process of setting a new breakpoint and running to the new breakpoint;

FIG. 14 illustrates a screenshot of reporting memory contents while debugging;

FIG. 15 illustrates another screenshot of reporting memory contents while debugging;

FIG. 16 illustrates a screenshot of source code for some representative debugger primitives;

FIG. 17 illustrates a screenshot of source code for making changes to register EAX;

FIG. 18 illustrates a screenshot of reporting memory contents after the contents of a register have been altered.

FIG. 19 illustrates a screenshot of source code for a program to be data mined;

FIG. 20 illustrates a screenshot of the disassembly results of the program data mining the program of FIG. 19;

FIG. 21 illustrates a screenshot of results of data mining;

FIG. 22 illustrates another screenshot of results of data mining;

FIG. 23 illustrates a screenshot of automatically generated software produced by an embodiment of an IF data miner; and

FIG. 24 illustrates a computing system having a user application embodied on a computer readable medium, the program comprising instructions configured to be executed by a processor.

### DETAILED DESCRIPTION

Standard anti-debugging techniques include the use of functions such as IsDebuggerPresent( ) and CheckRemoteDebuggerPresent( ). Timing checks, such as GetTickCount( ) may also be used. Checks for INT 3's or CC's, the use of hardware registers DR0-DR7 are also used. IDT checks and identifying thrown exceptions provide further indications of debugging that may be used by a program to ascertain whether it is subject to debugging. Traditional debuggers, such as IDA Pro and Ollydbg are Ring-3 debuggers, which must register with the OS. This makes them susceptible to IsDebuggerPresent( ) and CheckRemoteDebugger( ) checks. Other debuggers may be Ring-0, such as SoftICE and WinDbg. These are not detectable using IsDebuggerPresent( ) and CheckRemoteDebugger( ). However, SoftICE requires drivers and WinDbg requires the system to boot in debug-mode. This often requires the use of a second computer. Both types of debuggers use INT 3 and hardware registers DR0-DR7, IDT checks and thrown exceptions.

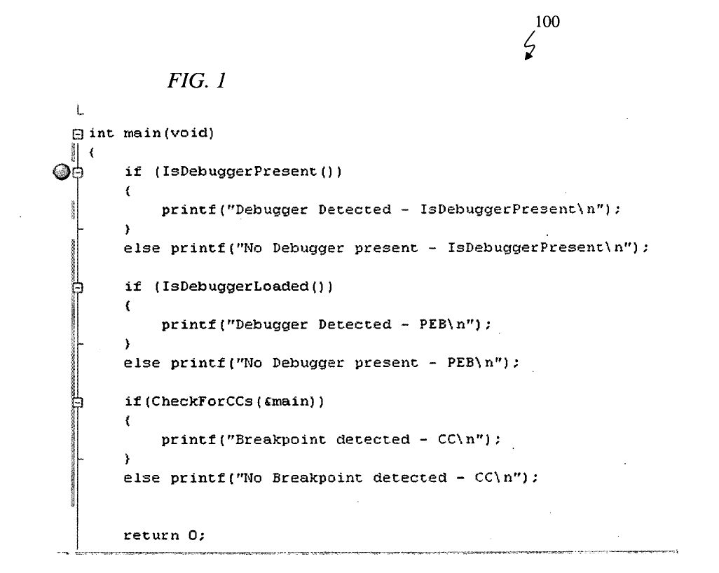

FIGS. 1-3 illustrate software programs 100-300 capable of detecting standard debuggers. As illustrated in FIG. 1, software program 100, contains calls to functions IsDebuggerPresent( ), IsDebuggerLoaded( ), and CheckForCCs( ). IsDebuggerPresent( ) and IsDebuggerLoaded( ) identify whether a computer's operating system (OS) has detected the presence of a debugger. Typically, a debugger registers with the OS, prior to having access to the memory space assigned by the OS to the program being debugged. Since many debuggers use a hex value 0xCC as a CPU instruction to halt execution of a program being debugged, such as a check for CCs, as done by CheckForCCs( ), can identify the presence of a debugger. Other checks include timing checks, such as GetTickCount( ), which can identify execution delays caused by debuggers, CheckRemoteDebuggerPresent( ), checking for the use of hardware registers, such as DR0-DR7, and the use of thrown exceptions.

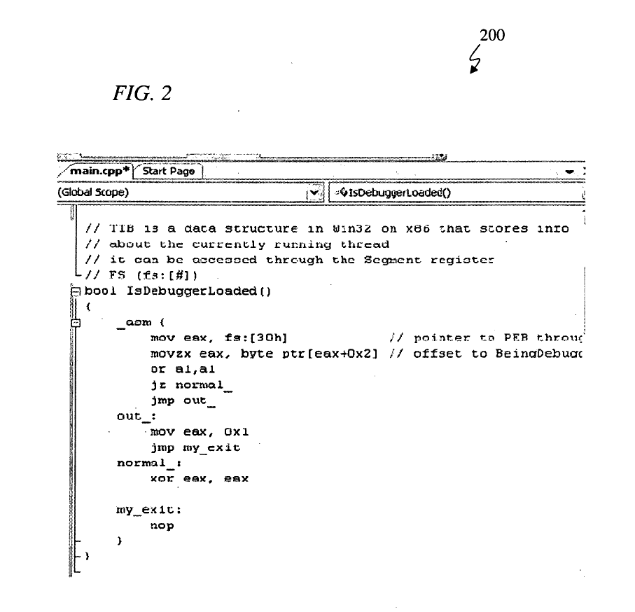

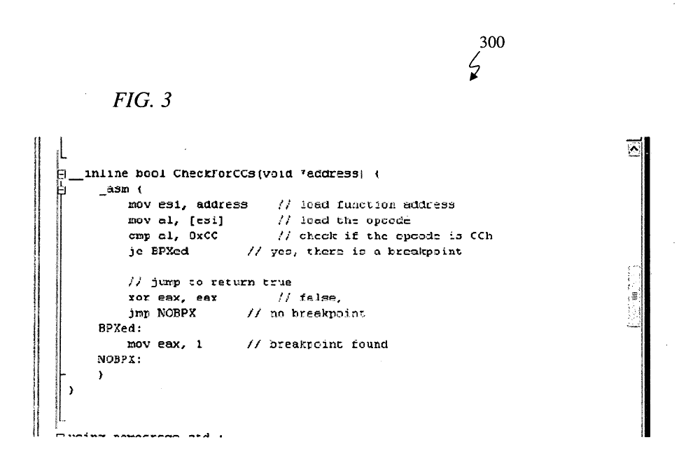

FIG. 2 illustrates a screenshot of another program 200, containing a version of an IsDebuggerLoaded( ) function. Specifically, FIG. 2 illustrates Assembly language mnemonics, along with comments explaining the operation of the function. FIG. 3 illustrates a screenshot of another program 300, containing a version of a CheckForCCs( ) function. Specifically, FIG. 3 illustrates Assembly language mnemonics, along with comments explaining the operation of how the function checks for 0xCC and the response if one is identified. Software programs 100-300 are typically embodied on a computer readable medium, for example volatile memory, non-volatile memory, optical media, magnetic media, or another medium. Program 100 may call functions identical to programs 200 and 300, or may call different versions. Software programs, such as programs 100-300, may run on one or more of several different types of computing apparatus and/or computing system, for example, a desktop computer, a notebook computer, an embedded device, a field programmable gate array (FPGAs), a personal digital assistant (PDAs), a music device, a gaming device, a communication device, and many other devices having processing capability.

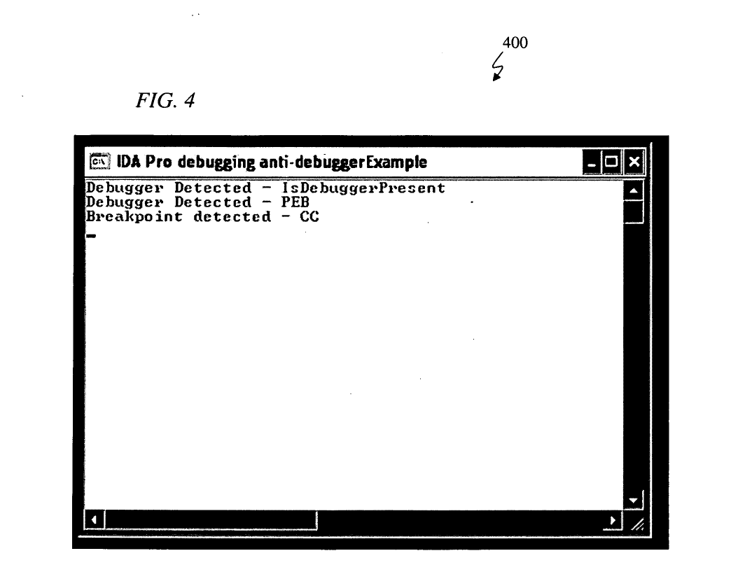

FIG. 4 illustrates a screenshot of the output program 100, when program 100 has been run under IDA Pro. IDA Pro is a commonly used, commercially available debugging and computing program analysis tool. As indicated in FIG. 4, program 100 detected IDA Pro by all three methods, IsDebuggerPresent( ), IsDebuggerLoaded( ), and CheckForCCs( ). Although program 100 merely reported detecting the debugger, other programs, such as malicious logic software, could respond differently. The responses could include suspending suspicious behavior, such that a user of the debugger would likely overlook the malicious capability of the software, or taking severe actions, including damaging other data on a computing system. One method of damaging data could be deleting files and/or attempting to reformat the primary hard drive. Other defensive measures could include forcing logic errors to interrupt an analysis effort.

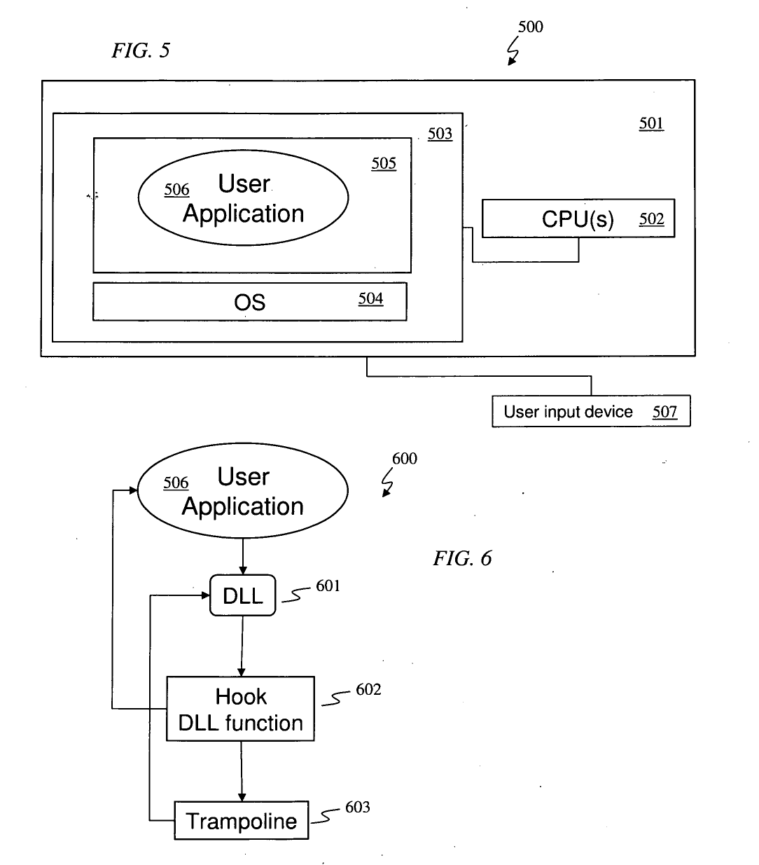

FIG. 5 illustrates a computing system 500 having a user application 506 embodied on a computer readable medium, the program comprising instructions configured to be executed by a processor. The instructions may include compiled instructions, or may comprise instructions in a line-interpreted language, configured to be executed within an interpreting environment, such as a java virtual machine or a BASIC environment. Computing system 500 comprises a computing apparatus 501 having one or more central processing units (CPUs) 502 coupled to memory 503. Memory 503 comprises a computer readable medium, for example volatile memory, although other mediums may be used, singly or together. Memory 503 comprises OS 504 and user process space 505, allocated by OS 504 for holding a user application 506. User input device 507 is coupled to computing apparatus 501, although for some computing systems, user input device 507 may be an integral part of computing apparatus 501 or may be remotely connected through a network. User input device 507 may comprise a keyboard, a mouse, a trackball, a touch screen, or another device suitable for receiving input by user application 506, OS 504, and/or other processes running in computing system 500. In some situations user input is automated, such as if application 506 is under automated control of another computer program, and the “user” is the other program, rather than a human.

FIG. 6 illustrates a software control flow detour process graph 600, adaptable for use as a stealthy internal function (IF) debugger and/or a data miner. As illustrated in FIG. 6, when user application 506 calls a dynamic link library (DLL) 601, execution jumps to hook DLL 602 for preprocessing, then to trampoline 603, back to DLL 601, then to hook DLL 602 for postprocessing, before returning to user application 506. User application 506 is unaware of any detours through hook DLL 602 and trampoline 603, and continues executing as if only DLL 601 had been called, and execution returned directly from DLL 601. In the illustrated process graph, DLL 601 has been modified from its original functionality, such that its first instructions have been replaced with a jump instruction to hook DLL 602. The original instructions, which have been overwritten by the jump instruction and may typically comprise 5 bytes, are copied into trampoline 603 for execution when the execution point passes to trampoline 603. Trampoline 603 further comprises a jump instruction back into DLL 601, offset by the number of bytes used in the jump instruction into hook DLL 602. For example, trampoline may jump to the byte 5 of DLL 601, if the jump instruction to hook DLL 602 requires 5 bytes (1 byte for the JPM and 4 bytes for the address of hook DLL 602).

Hook DLL 602 may comprise preprocessing instructions, postprocessing instructions, a jump to trampoline 603, and additional functionality. For example, hook DLL 602 may include instructions to save and restore the contents of the registers, as preprocessing and postprocessing. The addition functionality can include debugging functionality, such as reporting and modifying the contents of registers and other memory locations. Additionally, other functions may be implemented, including instruction tracing, breakpoints on memory access, process memory dumps (for memory grabs), a graphical user interface (GUI), interfaces with other debugging applications, such as creating plug-ins for IDA Pro, and searching of memory for identified strings. Data flow and code flow graphs may also be constructed using data available for reporting from hook DLL 602. Thus, hook DLL 602 provides debugging and data mining functionality, although it is undetectable using the debugging detection methods illustrated in FIGS. 1-3. This renders the new system a stealthy IF debugger.

A representative embodiment of a control flow detour process may leverage MicroSoft (MS) Detours for control flow modification and exploitation. MicroSoft has produced a library, named Detours, which includes functionality for intercepting Win32 dynamic link library (DLL) calls. MS Detours is described in Detours: Binary Interception of Win32 Functions, by Galen Hunt and Doug Brubacher, published in Proceedings of the 3rd USENIX Windows NT Symposium, Seattle, Wash., July 1999, the disclosure of which is hereby incorporated by reference. MS Detours is the first package on any platform to logically preserve the un-instrumented target function as a subroutine callable through the trampoline.

Some embodiments of a stealthy debugger leverage Microsoft (MS) Detours to inject jumps to reroute program control flow. Leveraging MS Detours allows a debugger to have command of a running executable, and further enable the insertion of breakpoints into a running application, such as user application 506. The breakpoints can be inserted at runtime, so that the program remains unmodified in its stored configuration, such as on a hard drive. Breakpoints are emulated by injecting a jump to slack space owned by an embodiment of an IF debugger. Slack space is space within process space 505 that is available for modification. Slack space is typically associated with locations of memory not containing instructions, such as space populated with NOP instructions. However, even space populated with instructions may be used as slack space, for example, instructions that have already been executed and will not be executed again. Using slack space allows for control of a running process, such as modification of memory and registers. Control is transferred back to the process by an “asm” statement from hooked code, for example, “_asm{jmp[Real_address]}.

Detours allows for selectively redirecting any DLL calls to a jump to slack space, by disassembling at least a portion of the DLL and copying the instructions to slack space. For example, Detours may disassemble the first couple of instructions of a DLL, copy them to slack space within the process space, and replace them with a jump to another slack space. Normal usage of Detours is for tracing function calls. However, an embodiment of a stealthy debugger may leverage Detours by hooking internal function calls within the application itself. Breakpoints may thus be emulated without using INT 3s, commonly identified as CCs on Intel x86 and other processors.

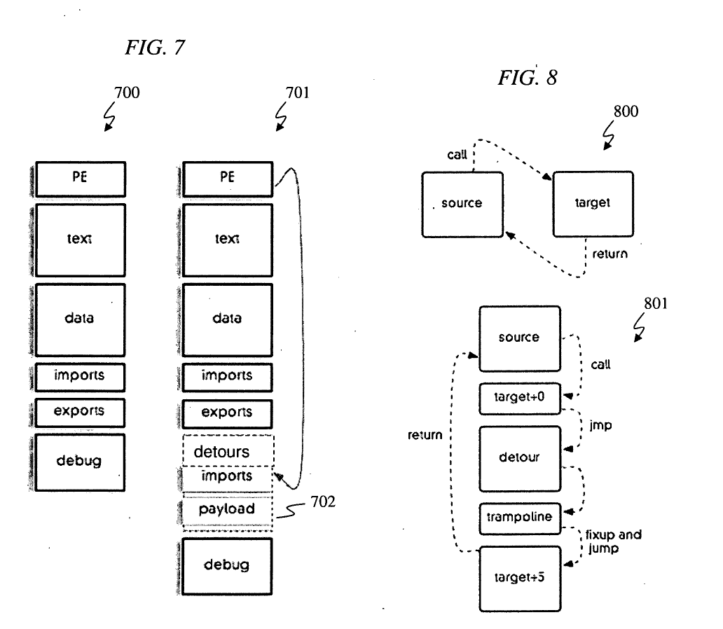

FIG. 7 illustrates a comparison between user memory spaces with and without MS Detours. Memory space graph 700 illustrates the normal Win 32 process space. Memory space graph 701 illustrates a Win 32 process space when using Detours. The addition of Detours payload 702 adds new functionality to the target potable executable (PE). Detours dynamically patches binary executables to intercept arbitrary Win32 function calls. It does this by adding a new payload section 702 to the PE image and redirecting the DLL import table to it. Detours uses this to hold dynamically generated code and data payloads as well as to load new DLLs into the target PE, such as into application 506. FIG. 8 illustrates a comparison between software control flow detour process graphs with and without MS Detours. Process graph 800 illustrates normal functionality, wherein a source calls a target. Process graphs 800 and 801 correspond to memory space graphs 700 and 701, respectively. Process graph 801 illustrates how Detours locates replaces the first few instructions in a target with a JMP into a detour function, which is typically loaded into a memory as a DLL when Detours attaches to the source program. As illustrated, Detours takes the original instructions from the JMP site in the target and moves them to a trampoline. When the detour is done, control is handed to the trampoline, which executes the original instructions copied from the target. Then control is handed back to the target function to execute the remainder of the target functionality.

However, prior art teachings regarding Detours are clear about preserving the contents of the registers. Specifically, page 5 of Detours: Binary Interception of Win32 Function states “Using the same calling convention insures that registers will be properly preserved and that the stack will be properly aligned between detour and target functions.” The reference further states, on pages 7 and 8, “Detours relies on adherence to calling conventions in order to preserve register values.” (emphasis added to both quotes) Clearly then, the prior art teachings regarding MS Detours then do not allow for the modification of registers within a debugging process, for example by receiving an instruction input by a user input device (such as a keyboard) to modify contents of a register, add a breakpoint (emulated or not), report memory contents, resume execution, or perform instruction tracing.

Thus, the prior art teachings regarding the use of Detours specifically teach away from the type of modification made by the inventive system and methods. Therefore, the inventive system and methods violate the teachings of the prior art.

Since MS Detours is the first package on any platform to logically preserve the un-instrumented target function as a subroutine callable through the trampoline (see page 5 of Detours: Binary Interception of Win32 Function), the inventive systems and methods are the first instances of to logically preserving the un-instrumented target function as a subroutine callable through the trampoline and receiving an instruction from a user input device to alter contents of a register in a computing system.

Since the preprocessing step may save register contents to the stack, and postprocessing step restores register contents from the stack, it is possible to alter contents of a register in two phases. First, the memory contents at the stack address of the saved register value is altered, and then this value is put into the register as part of the postprocessing. Additionally, the values in the registers may be reported by reporting the contents at the corresponding stack addresses. For example, a set of push and pop instructions can copy register contents onto and from the stack, although since the stack is typically a first-in-last-out (FILO) system, the restoration of the registers may preferably be done in the reverse order of the saving step.

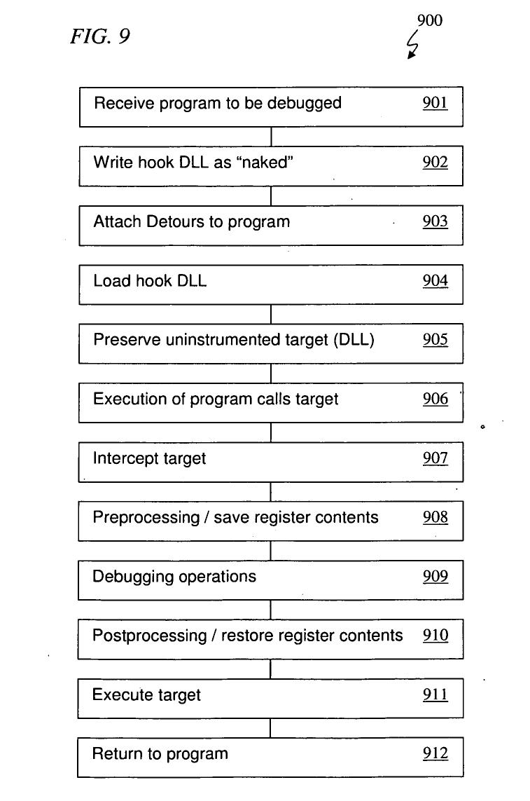

FIG. 9 illustrates a method 900 of stealthy debugging. In box 901, a program to be debugged is received, and a hook DLL, containing debugging functionality is written and compiled in box 902. If the hook DLL is defined as “naked” then the compiler will not automatically write a prolog and an epilog for the hook function. Prologs and epilogs are used by compilers to preserve register contents and local variables, often in the stack, when calling functions. These can be written manually when creating the hook DLL. Since many debugging operations may include modifying register contents, the automatic restoration of the register contents should be avoided. The author of the hook DLL writes the prolog and epilog to be compatible with the desired debugging operations, for example by moving register contents to and from the stack in a specific order, and storing the stack addresses for use in operations that involve reporting and modifying register contents.

The program is loaded into memory and Detours is attached to it in box 903, possibly by linking to it. In box 904, the hook DLL written in box 902, for example hook DLL 602 of FIG. 6, is loaded into memory. In box 905, Detours operates to dynamically set up the target DLL for interception using a trampoline, as described previously. This preserves the uninstrumented target. Then, in box 906, execution of the program calls the target, which is intercepted in box 907. Preprocessing 908 saves register contents, although other operations may also be performed. Debugging operations are performed by the hook DLL in box 909. Debugging operations may include many or all common debugging primitives, as well as advanced functionality, which may include emulating a breakpoint without the use of a CC. One method of pausing program execution by emulating a breakpoint is to use a loop with an exit criteria of a valid keyboard character return from getchar( ). Common debugging operations that may be performed by an embodiment of an IF debugger include modifying contents of a register used by the program, adding a CC breakpoint to the program, reporting contents of memory accessed by the program, resuming execution of the program, and performing instruction tracing of the program's executed instructions.

Postprocessing in box 910 restores register contents, possibly including any values changed on the stack, which are then copied into the registers as altered register contents. The target DLL is executed in box 911, partially in the trampoline, and then after jumping back to the target from the trampoline, within in the actual target itself. Execution then returns to the program in box 912.

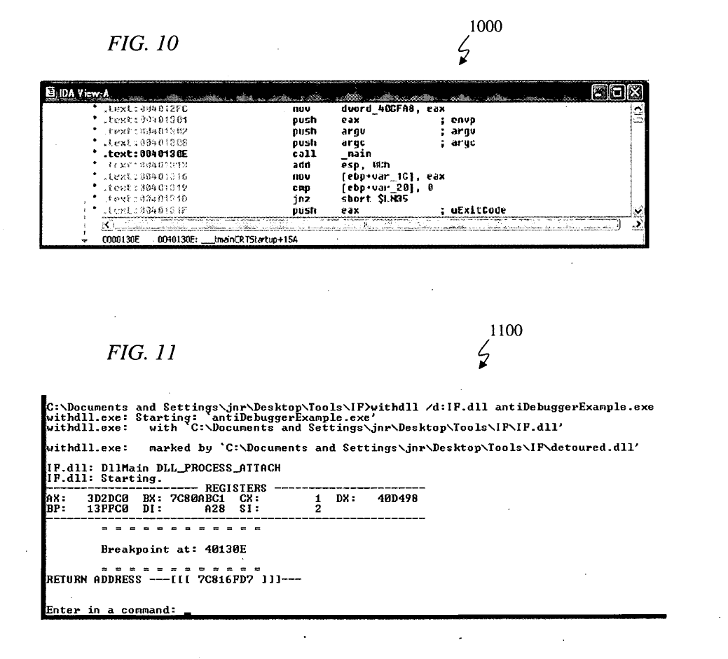

FIG. 10 illustrates a screenshot 1000 of a program to be debugged. A call to main( ) is at memory address 0x40130E, and a breakpoint, or emulated breakpoint, will be inserted at this address. FIG. 11 illustrates a screenshot 1100 taken while running software with an embodiment of a stealthy debugger. As indicated in FIG. 11, a breakpoint at 0x40130E has been hit, and the user is prompted to provide input identifying a debugging command. Note that the presence of a stealthy IF debugger has not been detected, and the register contents have been reported. An embodiment of an IF debugger may not rely on INT 3s (CCs) or the use of DR0-DR7 registers in a detectable manner. Further, embodiments of the debugger do not need to register a debugging process with the OS. The stealthy debugger is thus undetectable using many standard debugging detection techniques. The emulated breakpoint is added at runtime, by hooking the targeted address and injecting an unconditional jump instruction in place of an instruction that a user wishes to analyze. The destination address for the jump will be code usable for debugging purposes, such as printing out and/or changing register contents and/or other the contents of other memory locations. This hooking process transfers control of the program to the user, which enables the user to analyze software behavior. When execution is resumed, the debugger will redirect the program back to the original address through an indirect jump. The debugged program remains unmodified in storage, such as on a hard drive, and after the execution is completed.

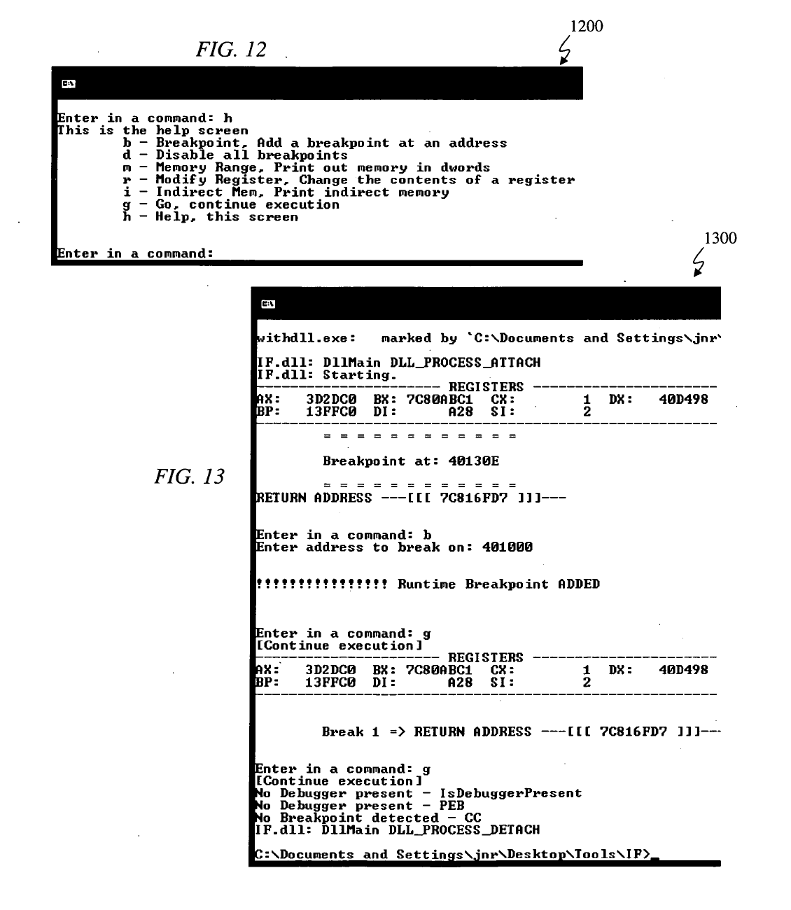

FIG. 12 illustrates a screenshot 1200 of the help screen of an IF debugger. Commands for various debugger primitives are illustrated, including adding a breakpoint, disabling breakpoints, reporting memory contents, modifying a register, and resuming execution. FIG. 13 illustrates a screenshot 1300 of a debugging process of adding a new breakpoint and running to the new breakpoint. FIG. 13 illustrates a continuation of the process started in FIG. 11, in which commands “b” and “g” are received from a user input device, for example a keyboard, to add a new breakpoint at memory address 0x401000 and run to it. As indicated in FIG. 13, no debugger is detected, even if the program contains all of the debugger detection capability described previously. Also illustrated is the output of the register contents when the new breakpoint is encountered.

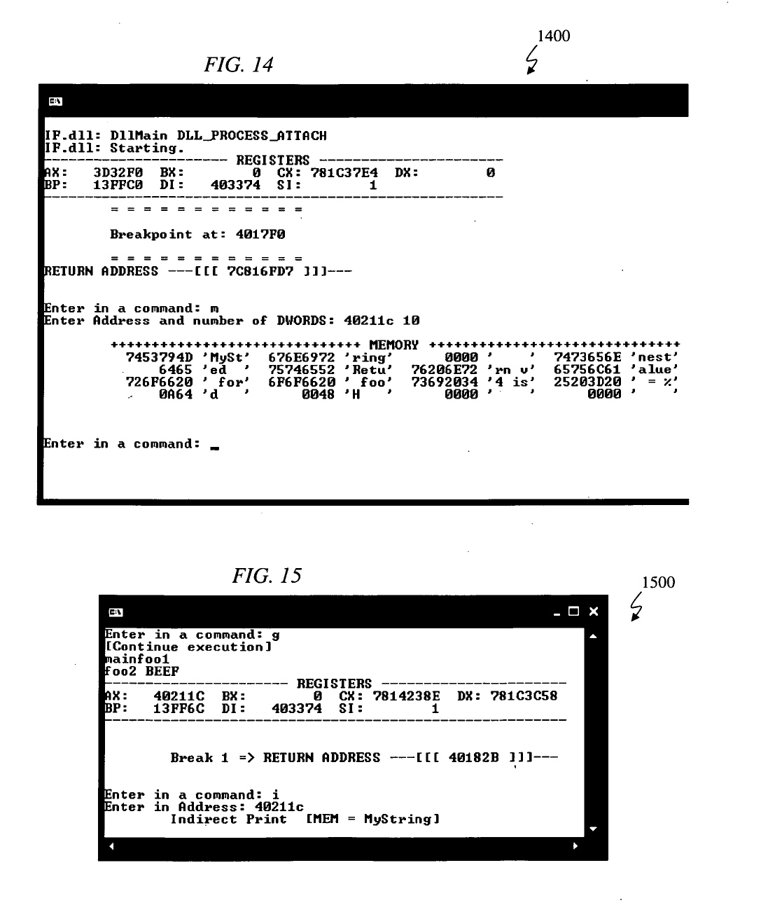

FIG. 14 illustrates a screenshot 1400 reporting memory contents while debugging with an embodiment of an IF debugger. As indicated in the figure, a breakpoint at address 0x4017F0 is encountered and an “m” command is issued, causing a prompt for the address and number of memory location to be reported. The address selected is 0x40211c, and 10 memory locations are selected for reporting. FIG. 15 illustrates a screenshot 1500 reporting memory contents while debugging with an embodiment of an IF debugger. However, as indicated in FIG. 15, an indirect memory report is requested, using the input instruction “i”. The contents are indicated as “MyString”.

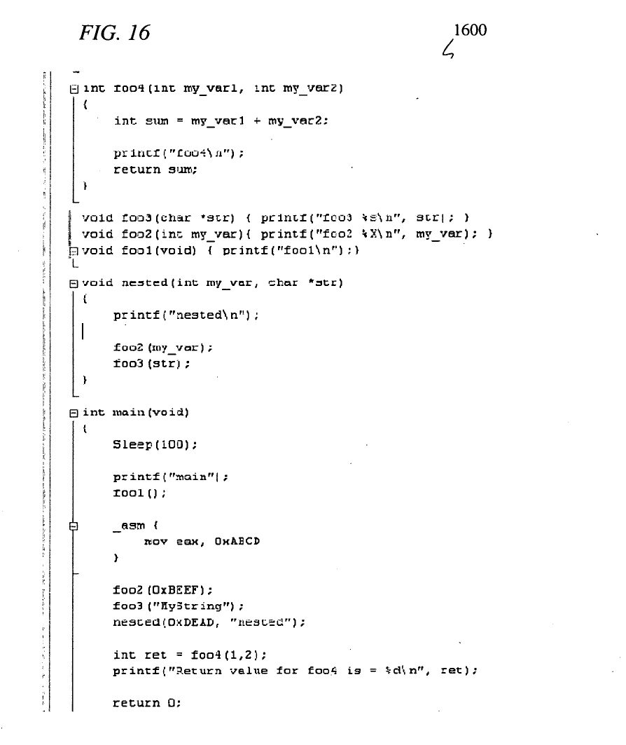

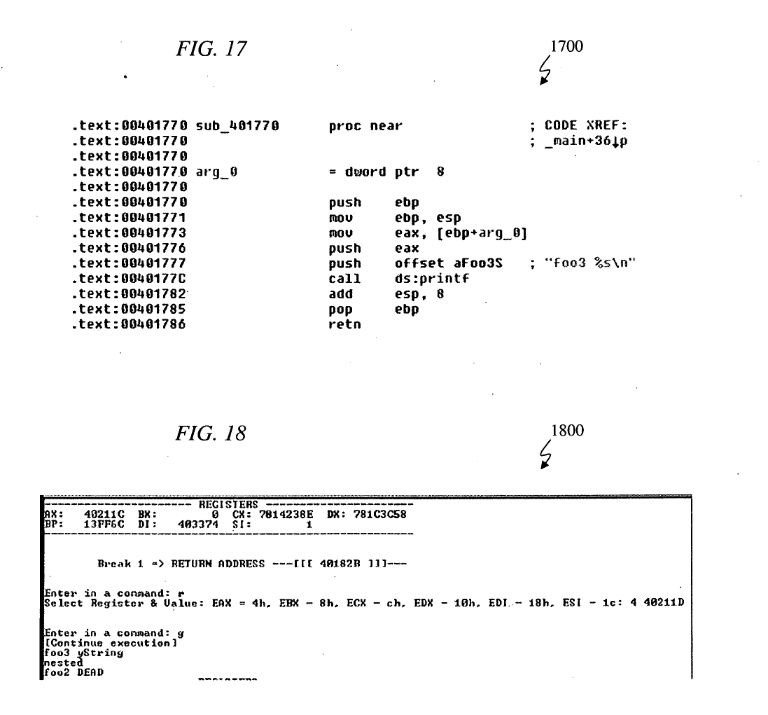

FIG. 16 illustrates a screenshot 1600 of source code for some representative debugger primitives. FIG. 17 illustrates a screenshot 1700 of source code for making changes to register EAX. In the figure, a command to push the contents of EAX to the top of the stack is shown.

FIG. 18 illustrates a screenshot 1800 reporting memory contents while debugging with an embodiment of an IF debugger, but after the contents of register EAX have been altered. As illustrated, the “r” command is input, indicating a change in register contents. The register EAX is identified by inputting 4, followed by the desired contents. The contents had been 0x4211c, but the change inserts 0x4211d, which is 1 higher. Since EAX pointed to the starting point of the string “MyString” in memory (see FIG. 14), incrementing the value of EAX, as indicated, causes EAX to now point to “yString” and miss the initial “M”. As indicated in FIG. 18, debugger primitives, such as those indicated in FIG. 16 are executed in conjunction with the memory reporting.

Traditional Ring-3 debuggers, such as IDA Pro and OllyDbg must register with the OS, and are therefore detectable using IsDebuggerPresent( ) and CheckRemoteDebugger( ). Ring-0 debuggers, such as SoftICE and WinDbg may escape detection by IsDebuggerPresent( ) and CheckRemoteDebugger( ), but requires drivers or the system to boot in debug-mode. Ring-0 debuggers also typically require the use of a second computing system to perform analysis. Both types of debuggers use INT 3 and hardware registers DR0-DR7, and are susceptible to thrown exceptions, and so may be detected. The present IF debugger escapes detection by these methods.

Utilizing MS Detours to inject jumps at runtime to reroute code allows an IF debugger to have command of running exe, so it can even insert breakpoints on code that is stored in a packed state. Breakpoints may be emulated by injecting a jump to slack space within the process space owned by the IF debugger. Use of the slack space then allows for control of running process, such as modifying memory and changing registers prior to transferring control back to the process by an asm statement from hooked code.

Static analysis of a program using IDA Pro can be a tedious process of running code through a debugger and annotating the disassembly. An IF data miner can facilitate the reverse engineering of data flow, control flow, and order of execution. An embodiment of an IF data miner may comprise an IDA plug-in. A plug-in uses IDA Pro's database structures to extract and parse names, addresses, parameter types, declaration types and return types from internal functions in a binary executable file. This information may be used to create a file, which is a compilation of hook instructions used by Detours to intercept calls to those functions.

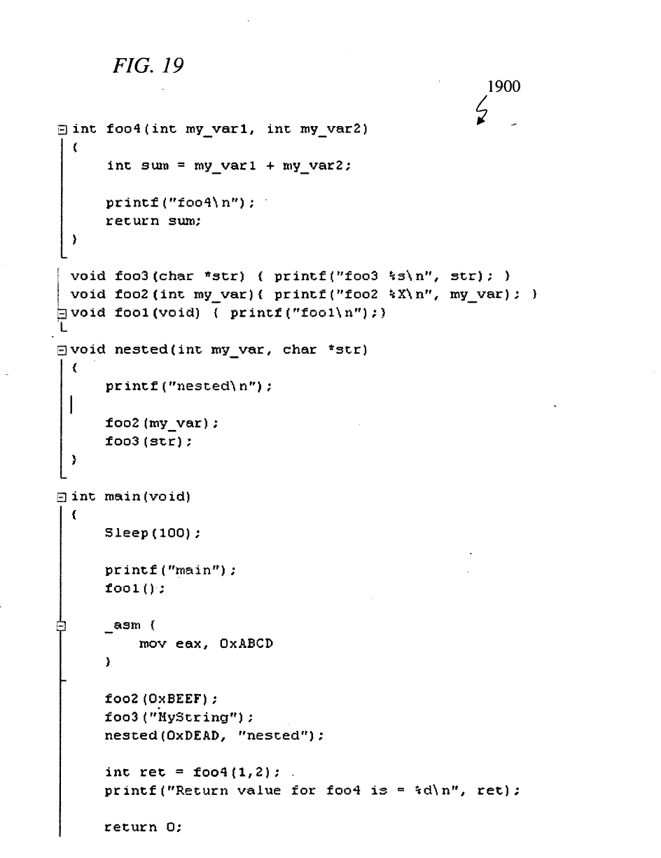

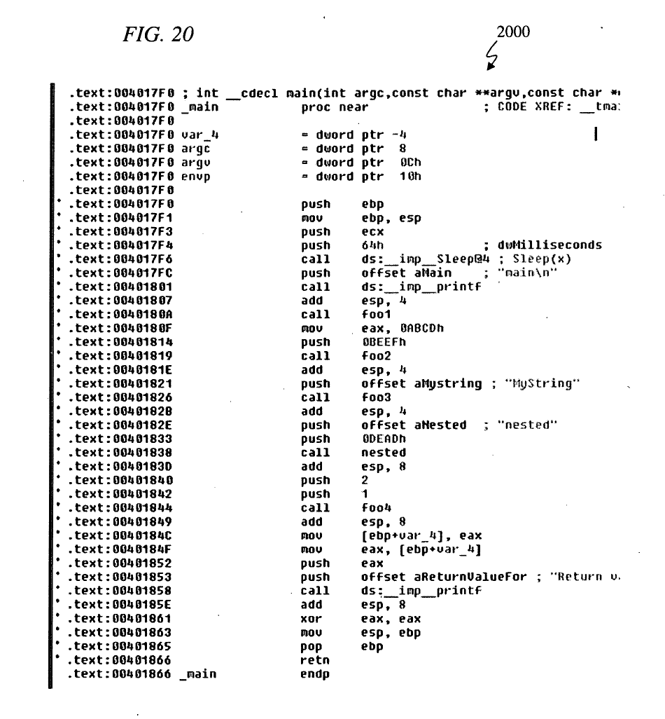

FIG. 19 illustrates a screenshot 1900 of source code for a program to be data mined. The source code includes functions foo1( ), foo2( ), foo3( ), foo4( ), and nested( ). FIG. 20 illustrates a screenshot 2000 of the disassembly results of the program data mining the program of FIG. 19. Between the screenshots 1900 and 2000, the program was compiled from source code to executable instructions, and then disassembled using IDA Pro. The illustrated functions are to be data mined, for example by reporting input and output parameters, return values, and the calling and return address. As implemented by MicroSoft, Detours works with _stdcall functions. However, in an embodiment of an IF tool, _cdecl, _thiscall, and _fastcall functions are supported. For example, an IF data miner is not limited to intercepting _stdcall functions, but may intercept even internal functions of differing types.

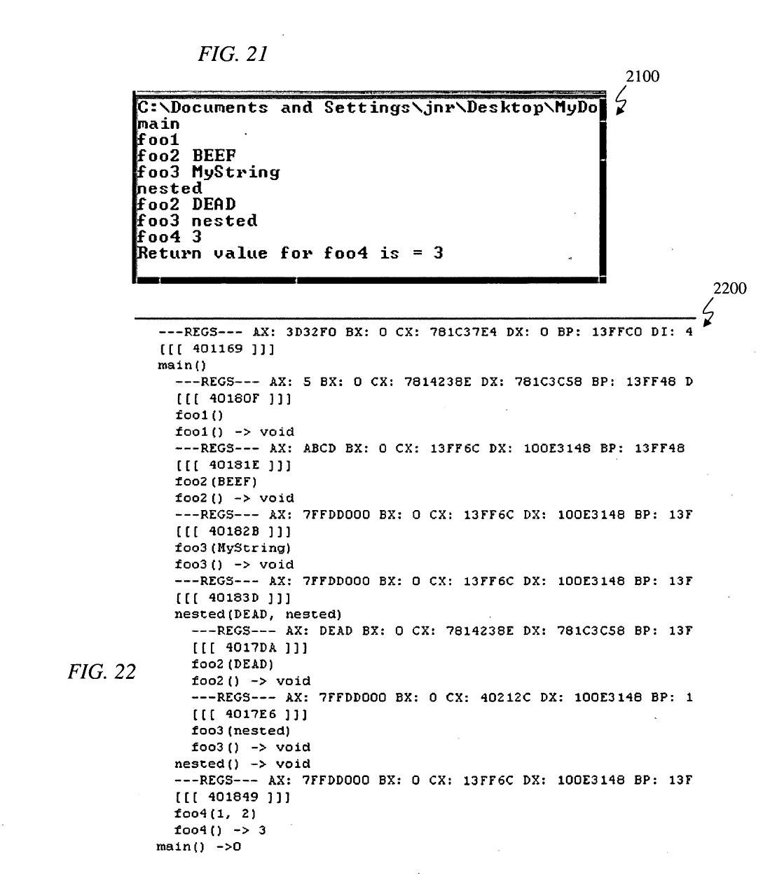

FIG. 21 illustrates a screenshot 2100 of results of data mining, as output to a screen during program execution. FIG. 22 illustrates a screenshot 2200 of results of data mining, as output to a data file, and viewed after program execution. As can be seen in FIGS. 21 and 22, all of foo1( ), foo2( ), foo3( ), foo4( ), and nested( ) have been called. The output data file includes register contents at the time a function was called, return addresses, for example 0x4017da, and parameters and return values. In the figures, register EAX is indicated as AX, and other registers are similarly abbreviated by omitting the leading “E”. The parameters 1, and 2 are indicated as being sent to foo4( ), and the return value of 3 is indicated for foo4( ). Parameters and returns are also indicated for the other functions. An IF data miner can control return values and completely circumvent function calls.

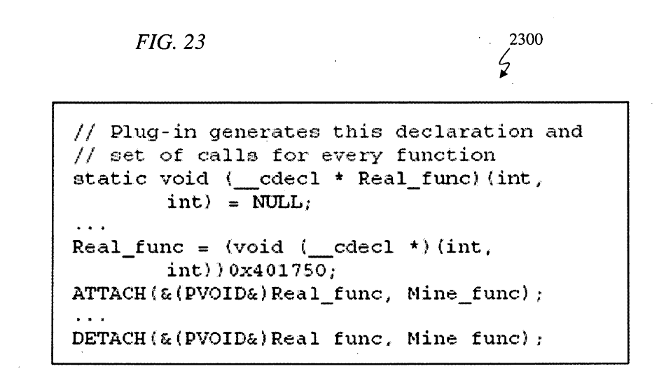

FIG. 23 illustrates a screenshot 2300 of automatically generated software produced by an embodiment of an IF data miner. An IDA Pro plug-in allows a user to automatically generate a detailed list of function calls performed by the target software, i.e. the program to be data mined. The automatically generated software may be in the form of a .cpp file, as illustrated in FIG. 23. Compiling this generated file allows for dumping of hooked functions and their parameters. For example, function calls in the original program can be dynamically replaced with jumps to the generated software, which creates the output illustrated in FIGS. 21 and 22. The generated software can be put in some slack space within the process space. Another IDA Pro plug-in parses the output of the data miner, generated during the execution of the software, and automates annotation of a database of function calls, register values and parameters.

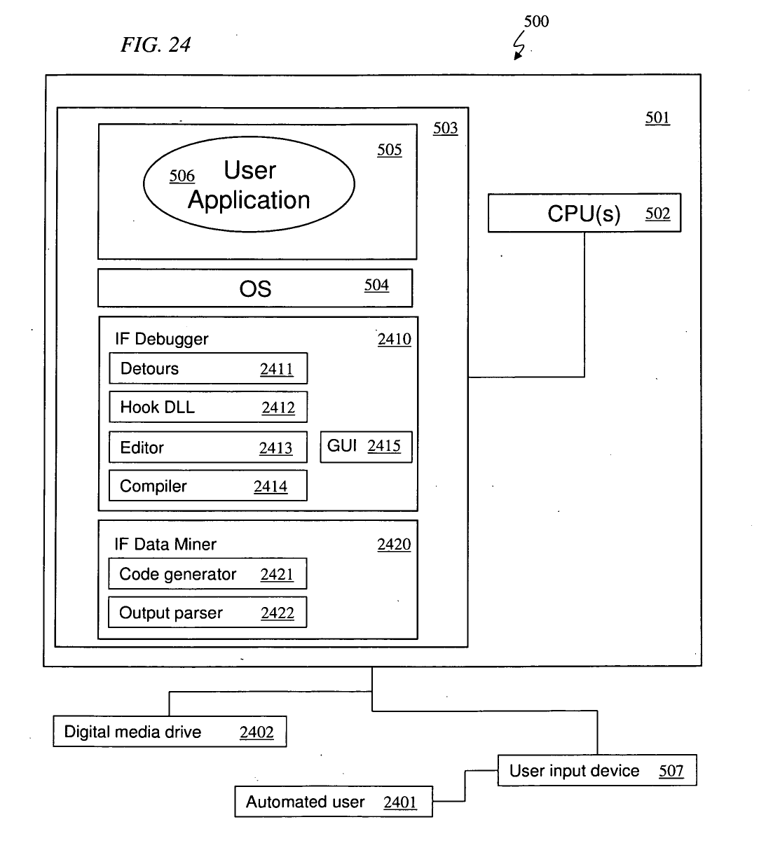

FIG. 24 illustrates computing system 500 also comprising an IF debugger 2410 and an IF data miner 2420, operating as described previously. Also illustrated in FIG. 24 is an automated user 2401, although it should be understood that a human user may also use IF debugger 2410 and an IF data miner 2420, for example through typical human user input/output (I/O devices such as a video display, mouse and keyboard. Automated user 2401 may comprise an artificial intelligence program running on computing system 500 or on another computing system. A digital media drive (DMD) 2402 is coupled to computing apparatus 501, and may comprise a magnetic media, an optical media, or another computer readable media type. Any of the programs described herein may be read from, written to, and/or otherwise stored on DMD 2402.

IF Debugger 2410 comprises Detours 2411, a hook function 2412, which may be similar to hook DLL 602 of FIG. 6, an editor 2413, for writing code for hook function 2412, a compiler 2414 for compiling hook function 2412, and a GUI 2415 for outputting data and receiving user input. It should be understood that additional hook function types, besides DLLs, may be used in embodiments of an IF debugger. IF data miner 2420 may comprise any or all of the described portions of IF debugger 2410, as well as a code generator 2421, for automatically generating code, such as is illustrated in FIG. 23, and an output parser for annotating a database of function call information.

Software that attempts to impede reverse engineering via dynamic analysis, by using anti-debugging or packing measures can be thwarted by using a stealthy internal function (IF) data miner. Data mining through an IF utility can aid reverse engineering by constructing a data and control flow analysis after a single run of an executable program. For example, a historical list of functions called, along with the calling and return parameters, may be produced. The methods disclosed herein may be performed using a computer program embodied on a computer readable medium, for example, an optical medium, a magnetic medium, or non-volatile memory. Such software may be executable by a processor or multiple processors. Further, hardware apparatus, for example, an application specific integrated circuit (ASIC) and/or an FPGA may be utilized. Is should also be understood that, as further advances are made in computer-related technology, the invention may take advantage of such advances.

Although the present invention and its advantages have been described, it should be understood that various changes, substitutions and alterations can be made herein without departing from the spirit and scope of the invention as defined by the appended claims. Moreover, the scope of the present application is not intended to be limited to the particular embodiments of the process, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method comprising:
logically preserving an uninstrumented target function as a subroutine callable through a trampoline;
intercepting the target function; and
receiving an instruction from a user input device to add a breakpoint to a program containing a call to the target function.

2. The method of claim 1 further comprising:
attaching an interception library to the program; and
executing the program at least up through the function call.

3. The method of claim 2 wherein attaching an interception library to a program comprises attaching Detours to a program.

4. The method of claim 2 further comprising:
loading a hook function into memory.

5. The method of claim 4 wherein loading a hook function into memory comprises loading a DLL into a process space of the program.

6. The method of claim 1 further comprising:
compiling a hook function comprising instructions for receiving the instruction from a user input device.

7. The method of claim 6 further comprising:
declaring the hook function as naked;
writing a prolog for the hook function; and
writing an epilog for the hook function.

8. The method of claim 1 further comprising:
after intercepting the target function and receiving an instruction from a user input device, executing the target function.

9. The method of claim 1 wherein receiving an instruction from a user input device to add a breakpoint comprises receiving an instruction from a user input device to add an emulated breakpoint.

10. The method of claim 1 further comprising:
performing at least one operation selected from the list consisting of:
modifying contents of a register used by the program,
reporting contents of memory accessed by the program,
resuming execution of the program, and
performing instruction tracing of the program's executed instructions.

11. The method of claim 10 wherein modifying contents of a register comprises writing a value on a stack and copying the value from the stack to the register.

12. The method of claim 10 wherein reporting memory contents comprises reporting register contents.

13. A method comprising:
logically preserving an uninstrumented target function as a subroutine callable through a trampoline;
executing a program at least up through a call to the target function;
intercepting the target function; and
receiving an instruction from a user input device to perform at least one operation selected from the list consisting of:
adding a breakpoint to the program,
modifying contents of a register used by the program,
reporting contents of memory accessed by the program,
resuming execution of the program, and
performing instruction tracing of the program's executed instructions.

14. A computer program embodied on a computer readable medium and configured to be executed by a processor, the program comprising:
code for copying instructions from a target function to a trampoline;
code for replacing the copied instructions with a jump to a hook function;
code for performing at least one debugging operation within the hook function; and
code for inserting a jump to the target function within the trampoline.

15. The computer program of claim 14 wherein the code for performing at least one debugging operation comprises code for inserting a breakpoint into a program.

16. The computer program of claim 15 wherein the code for inserting a breakpoint into a program comprises code for inserting an emulated breakpoint into a program.

17. The computer program of claim 14 wherein the code for copying instructions from a target function to a trampoline, the code for replacing the copied instructions with a jump to a hook function, and the code for inserting a jump to the target function within the trampoline together comprises a library for intercepting binary functions.
